(19) United States
(12) Patent Application Publication
(10) Pub. No.: US 2024/0362714 A1
(43) Pub. Date: Oct. 31, 2024

(54) METHOD, SYSTEM, AND COMPUTER PROGRAM PRODUCT FOR PERFORMING ARBITRAGE TRANSACTIONS ON A BLOCKCHAIN NETWORK WITH A SINGLE BLOCKCHAIN TRANSACTION

(71) Applicant: Moser Technologies, LLC, Baltimore, MD (US)

(72) Inventor: Kyle Moser, Baltimore, MD (US)

(21) Appl. No.: 18/648,899

(22) Filed: Apr. 29, 2024

Related U.S. Application Data
(60) Provisional application No. 63/498,845, filed on Apr. 28, 2023.

(51) Int. Cl. G06Q 40/04; G06Q 20/38

(52) U.S. Cl. CPC G06Q 40/04; G06Q 20/389

(57) ABSTRACT

Methods, systems, and computer program products are provided for performing a transaction on a blockchain network including an arbitrage transaction within a single blockchain transaction. A computer-implemented method may include receiving a request for a trade from a client device, wherein the request for the trade comprises a first amount of a first cryptocurrency; generating a blockchain transaction comprising a first trade message for the first amount of the cryptocurrency and a second trade message for a second amount of a second cryptocurrency; and executing the first trade message and the second trade message on a blockchain network to execute a first trade associated with the first trade message and to execute a second trade associated with the second trade message.

This U.S. Non-Provisional application is related to and claims priority to U.S. Provisional Application No. 63/498,845 filed on Apr. 28, 2023, the entire contents of which are incorporated herein by reference.

### BACKGROUND

### 1. Field

This disclosure relates generally to blockchain networks and blockchain transactions, and, in some non-limiting embodiments, systems, methods, and computer program products for performing transactions with multiple messages including an arbitrage transaction on a blockchain network within a single blockchain transaction.

### 2. Technical Considerations

A blockchain network may include a ledger (e.g., a series of recorded, ordered data elements). The blockchain network may be composed of one or more blocks (e.g., one or more data elements) that increment in number. The increment in number may be referred to as a height of the blockchain network (e.g., a height of 1, 2, 3, or more blocks). Data included in each block may be verified through a cryptographic signature, thus making the data included in each block reliable and/or trustworthy.

In some blockchain systems, the underlying software instructions that are used to operate a blockchain network may facilitate execution of transactions on the blockchain network. In some instances, a transaction (e.g., a blockchain transaction) may include a transaction to conduct a trade of a currency for a cryptocurrency, or a trade of a first cryptocurrency for a second cryptocurrency. With some blockchain networks and/or blockchain applications used to conduct transactions, one or more pools of cryptocurrencies may be stored. For example, a blockchain application used to conduct transactions may include a first pool having 1000 first cryptocurrency tokens and 1000 second cryptocurrency tokens. The first pool thus represents a 1:1 ratio of price for the first cryptocurrency token against the second cryptocurrency token. When a trade of, for example, 500 first cryptocurrency for a second cryptocurrency is conducted on the blockchain network (e.g., a trade of 500 first cryptocurrency tokens for an amount of second cryptocurrency tokens), then 500 first cryptocurrency tokens are added to the first pool. This addition of 500 first cryptocurrency tokens to the first pool may have an affect on the ratio of price for the first cryptocurrency token against the second cryptocurrency token. Since there are generally a plurality of pools associated with various cryptocurrencies, and since each trade of a cryptocurrency for another cryptocurrency may change the price of the various cryptocurrencies within a blockchain system, then different ratios of prices for the various cryptocurrencies may be achieved by conducting transactions on using the blockchain system and/or blockchain network.

The ability to achieve different ratios of price may lead to opportunities for arbitrage (e.g., a simultaneous purchase and sale of an asset to exploit small differences in price). However, arbitrage opportunities may be currently exploited by two techniques. (1) The first is by the use of various bots (e.g., automated computer programs design to run specific tasks with minimal human intervention) to conduct transactions on a blockchain network. Bots may be inefficient or may periodically be unsuccessful in conducting a transaction for an arbitrage opportunity because the ability of a bot to successfully conduct a transaction for an arbitrage opportunity depends on speed of detection of the arbitrage opportunity and speed of requesting and conducting the transaction. In an ecosystem with a plurality of bots attempting to achieve a same goal, the bots are up against a race condition for successfully conducting the transaction for the arbitrage opportunity. The existence of the race condition can lead to many failed transactions for the plurality of bots attempting to achieve the same goal. (2) The second technique is by bidding for the ability to place a transaction in a favorable position within a block on the blockchain network.

### SUMMARY

Accordingly, provided are methods, systems, and computer program products for performing transactions with multiple messages including an arbitrage transaction on a blockchain network within a single blockchain transaction.

According to non-limiting embodiments, provided is a computer-implemented method. In some non-limiting embodiments, the method may include receiving a request for a trade from a client device. The request for the trade may include a first amount of a first cryptocurrency. The method may further include generating a blockchain transaction including a first trade message for the first amount of the cryptocurrency and a second trade message for a second amount of a second cryptocurrency. The method may further include executing the first trade message and the second trade message on a blockchain network to execute a first trade associated with the first trade message and to execute a second trade associated with the second trade message.

According to non-limiting embodiments, provided is a computer-implemented method. In some non-limiting embodiments, the method may include receiving a request for a trade from a client device. The request for the trade may include a first amount of a first cryptocurrency. The method may further include simulating a blockchain transaction based on the request for the trade to produce a trade result comprising a difference in amounts of cryptocurrency. The method may further include generating a blockchain transaction comprising a first trade message for the cryptocurrency and a second trade message for the cryptocurrency. The second trade message may include the difference in amounts of cryptocurrency. The method may further include transmitting the blockchain transaction to a blockchain network.

According to non-limiting embodiments, provided is a system including at least one processor and at least one non-transitory computer-readable medium storing instructions that, when executed by the at least one processor, cause the at least one processor to perform the computer-implemented methods.

According to non-limiting embodiments, provided is a computer program product including at least one non-transitory computer-readable medium including program instructions that, when executed by at least one processor, cause the at least one processor to perform the computer-implemented methods.

According to non-limiting embodiments, provided is a system including at least one processor and an application programming interface (API) configured to communicate with a client device and at least one decentralized exchange system. The API may be configured to cause the at least one processor to receive a request for a trade from the client device. The request for the trade may include a first amount of a first cryptocurrency. The API may further cause the at least one processor to generate a blockchain transaction comprising a first trade message for the first amount of the cryptocurrency and a second trade message for a second amount of a second cryptocurrency. The API may further cause the at least one processor to transmit the blockchain transaction to a blockchain network via the decentralized exchange system.

According to non-limiting embodiments, provided is a system, including a blockchain network and a smart contract deployed on the blockchain network. The smart contract may be configured to execute one or more messages including a difference in amounts of cryptocurrency (e.g., as in an arbitrage opportunity) to produce a trade result.

The system may further include at least one processor. The at least one processor may be programmed or configured to receive a blockchain transaction from a client device.

The blockchain transaction may include a first trade message and a second trade message. The second trade message may include instructions to cause execution of the smart contract. The processor may be further programmed or configured to execute the first trade message and the second trade message on the blockchain network. The second trade message may include the difference in amounts of cryptocurrency and the second trade message may be executed via the smart contract.

Other non-limiting embodiments will be set forth in the following numbered clauses:

Clause 1: A computer-implemented method, comprising: receiving, with at least one processor, a request for a trade from a client device, wherein the request for the trade comprises a first amount of a first cryptocurrency; generating, with at least one processor, a blockchain transaction comprising a first trade message for the first amount of the cryptocurrency and a second trade message for a second amount of a second cryptocurrency; and executing, with at least one processor, the first trade message and the second trade message on a blockchain network to execute a first trade associated with the first trade message and to execute a second trade associated with the second trade message.

Clause 2: The computer-implemented method of clause 1, wherein the first trade message and the second trade message are executed via a smart contract, and wherein the second amount of the second cryptocurrency is recalculated by the smart contract.

Clause 3: The computer-implemented method of clauses 1 or 2, wherein the first trade associated with the first trade message is executed prior to executing the second trade associated with the second trade message.

Clause 4: The computer-implemented method of any of clauses 1-3, wherein executing the first trade message and the second message comprises: executing the first trade associated with the first trade message to swap the first amount of cryptocurrency; and executing the second trade associated with the second trade message to swap the second amount of cryptocurrency, wherein the second trade represents an arbitrage swap.

Clause 5: The computer-implemented method of any of clauses 1-4, further comprising: recording the first trade and the second trade on a block in the blockchain network.

Clause 6: The computer-implemented method of any of clauses 1-5, wherein the first trade message and the second trade message each comprise one or more pool identifiers, each pool identifier representing a pool of one or more cryptocurrencies.

Clause 7: A computer-implemented method, comprising: receiving, with at least one processor, a request for a trade from a client device, wherein the request for the trade comprises a first amount of a first cryptocurrency; simulating, with at least one processor, a blockchain transaction based on the request for the trade to produce a trade result comprising a difference in amounts of cryptocurrency; generating, with at least one processor, a blockchain transaction comprising a first trade message for the cryptocurrency and a second trade message for the cryptocurrency, wherein the second trade message comprises the difference in amounts of cryptocurrency; and transmitting, with at least one processor, the blockchain transaction to a blockchain network.

Clause 8: A computer-implemented method, comprising: receiving, with at least one processor, a request for a trade from a client device, wherein the request for the trade comprises a first amount of a first cryptocurrency; generating, with at least one processor, a blockchain transaction comprising a first trade message for the first amount of the cryptocurrency and a second trade message for a second amount of a second cryptocurrency; transmitting, with at least one processor, the blockchain transaction to a blockchain network.

Clause 9: The computer-implemented method of any of clauses 1-8, wherein the first trade message and the second trade message are executed on the blockchain network.

Clause 10: The computer-implemented method of any of clauses 1-9, wherein the first trade message and the second trade message are executed via a smart contract, and wherein the second amount of the second cryptocurrency is recalculated by the smart contract.

Clause 11: The computer-implemented method of any of clauses 1-10, wherein the blockchain transaction is verified on the blockchain network.

Clause 12: A system, comprising: at least one processor; at least one non-transitory computer-readable medium storing instructions that, when executed by the at least one processor, cause the at least one processor to perform the method of any preceding clause.

Clause 13: A computer program product comprising at least one non-transitory computer-readable medium including program instructions that, when executed by at least one processor, cause the at least one processor to perform the method of any one of clauses 1-11.

Clause 14: A system, comprising: at least one processor; and an application programming interface (API) configured to communicate with a client device and at least one decentralized exchange system, wherein the API is configured to cause the at least one processor to: receive a request for a trade from the client device, wherein the request for the trade comprises a first amount of a first cryptocurrency; generate a blockchain transaction comprising a first trade message for the first amount of the cryptocurrency and a second trade message for a second amount of a second cryptocurrency; and transmit the blockchain transaction to a blockchain network via the decentralized exchange system.

Clause 15: A system, comprising: a blockchain network; a smart contract deployed on the blockchain network, the smart contract configured to execute one or more messages including a difference in amounts of cryptocurrency to produce a trade result; and at least one processor, wherein the at least one processor is programmed or configured to: receive a blockchain transaction from a client device, wherein the blockchain transaction comprises a first trade message and a second trade message, the second trade message comprising the smart contract; and execute the first trade message and the second trade message on the blockchain network, wherein the second trade message comprises the difference in amounts of cryptocurrency and is executed via the smart contract.

Clause 16: The system of clause 14 or 15, wherein the at least one processor is programmed or configured to perform the method of any of clauses 1-11.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting embodiments that are illustrated in the accompanying schematic figures, in which:

FIG. 1 is a schematic diagram of a system for performing transactions with multiple messages including an arbitrage transaction on a blockchain network within a single blockchain transaction according to some non-limiting embodiments;

FIG. 2 is a flow diagram of a process for performing transactions with multiple messages including an arbitrage transaction on a blockchain network within a single blockchain transaction according to some non-limiting embodiments;

FIG. 3 is a flow diagram of another process for performing transactions with multiple messages including an arbitrage transaction on a blockchain network within a single blockchain transaction according to some non-limiting embodiments;

FIG. 4 is a diagram of an exemplary environment in which methods, systems, and/or computer program products, described herein, may be implemented according to some non-limiting embodiments; and

FIG. 5 is a schematic diagram of example components of one or more devices of FIG. 1 and/or FIG. 4 according to some non-limiting embodiments.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments of the disclosed subject matter. Hence, specific dimensions and other physical characteristics related to the embodiments disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “client” and “client device” may refer to one or more client-side devices or systems used to initiate or facilitate a network connection. As an example, a “client device” may refer to one or more computing devices used by a user, one or more personal computers used by a user, one or more mobile devices used by a user, and/or the like. In some non-limiting embodiments, a client device may be an electronic device configured to communicate with one or more networks. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a user, a corporation, and/or the like) that owns, utilizes, and/or operates a client device.

As used herein, the term “server” may refer to or include one or more computing devices that are operated by or facilitate communication and processing for multiple parties (e.g., clients, client devices, users, and/or the like) in a network environment, such as the Internet, although it will be appreciated that communication may be facilitated over one or more public or private network environments and that various other arrangements are possible. Further, multiple computing devices (e.g., servers, mobile devices, etc.) directly or indirectly communicating in the network environment may constitute a “system.” Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the disclosed subject matter are directed to systems, methods, and computer program products for performing transactions with multiple messages including an arbitrage transaction on a blockchain network within a single blockchain transaction. For example, non-limiting embodiments of the disclosed subject matter provide methods, systems, and computer program products for receiving a request for a trade from a client device. The request for the trade may include a first amount of a first cryptocurrency. Non-limiting embodiments may generate a blockchain transaction including a first trade message for the first amount of the cryptocurrency and a second trade message for a second amount of a second cryptocurrency. Non-limiting embodiments may execute the first trade message and the second trade message on a blockchain network to execute a first trade associated with the first trade message and to execute a second trade associated with the second trade message.

Non-limiting embodiments provide techniques and systems that facilitate conducting an arbitrage trade in conjunction with a standard trade (e.g., a trade initiated by a user request, a user trade, and/or the like) on a blockchain network. For example, a user trade and an arbitrage trade (e.g., a trade taking advantage of a difference in price in one or more pools of cryptocurrencies, a price favorable trade, and/or the like) may be executed within a single blockchain transaction on a blockchain network. Conceptually, the arbitrage trade is executed after the user trade in time. However, since both trades are executed using separate trade messages within a single blockchain transaction on a blockchain network, the arbitrage trade happens virtually at the same time as the user trade, thus eliminating the race condition that a plurality of bots may face when trying to execute an arbitrage trade on a blockchain network following an executed user trade. For example, blockchain transactions may be atomic in nature, thus, the trade messages (e.g., both the trade message for a user trade and a trade message for an arbitrage trade) are guaranteed to execute one after the other (e.g., virtually at the same time). In this way, non-limiting embodiments eliminate any race condition when conducting arbitrage trades.

The need to use a bot to successfully capture an arbitrage opportunity is eliminated and an arbitrage trade is virtually guaranteed using a blockchain transaction including at least one user trade message and an arbitrage trade message within the same blockchain transaction. That is, bots will no longer need to be used to “arbitrage” a trade. The use of bots may result in failed arbitrage trades, increasing load on a network. Use of non-limiting embodiments may thus decrease network spam and traffic on a blockchain network.

The user trade message may be executed via a smart contract or other software function and the arbitrage message may be executed via a smart contract or other software function thereafter. The arbitrage trade is determined automatically based on the user trade and may be automatically added to the blockchain transaction to be added to a blockchain network, thus increasing system efficiency and reducing the need for bots and eliminating any race condition to successfully capture an arbitrage opportunity. Thus, placing at least two executable messages within a single blockchain transaction may enhance the use of blockchain technology while eliminating the problems associated with using bots and missing out on valuable blockchain transactions because of technical issues associated with bots.

Additionally, using non-limiting embodiments, an arbitrage transaction may be determined prior to executing the user trade and the arbitrage trade may be added to the blockchain transaction along with the user trade such that both trades are executed within the same blockchain transaction on a blockchain network. Non-limiting embodiments may determine the arbitrage trade before the user trade is executed (e.g., via simulation) to provide an enhancement to blockchain technology that may allow for the use of arbitrage trades within the same blockchain transaction without having to rely on bots or other methods of determining an arbitrage trade after a user trade is executed on the blockchain, thus resulting in a race condition between bots or other software applications attempting to determine an arbitrage trade and attempting to execute the arbitrage trade after the user trade is executed on the blockchain network.

In this way, the performance of non-limiting embodiments of the systems, methods, and/or computer program products described herein may provide an improvement to blockchain technology by allowing for multiple transactions to occur at effectively the same time and be recorded on the blockchain at the same time as more than one trade message may be executed within a single blockchain transaction. Additionally, by determining an arbitrage trade before a user trade is executed allows for arbitrage trades to be executed effectively at the same time as the user trade, thus eliminating a race condition that may occur after the user trade has been executed and recorded on the blockchain where one or more software applications (e.g., bots) may race to determine the arbitrage trade and to execute the arbitrage trade on the blockchain network. Thus, non-limiting embodiments provide a system, method, and computer-program product which provide an improvement to existing blockchain technology to facilitate novel properties of simulating an arbitrage opportunity off-chain, then packaging user and arbitrage trades into a single transaction.

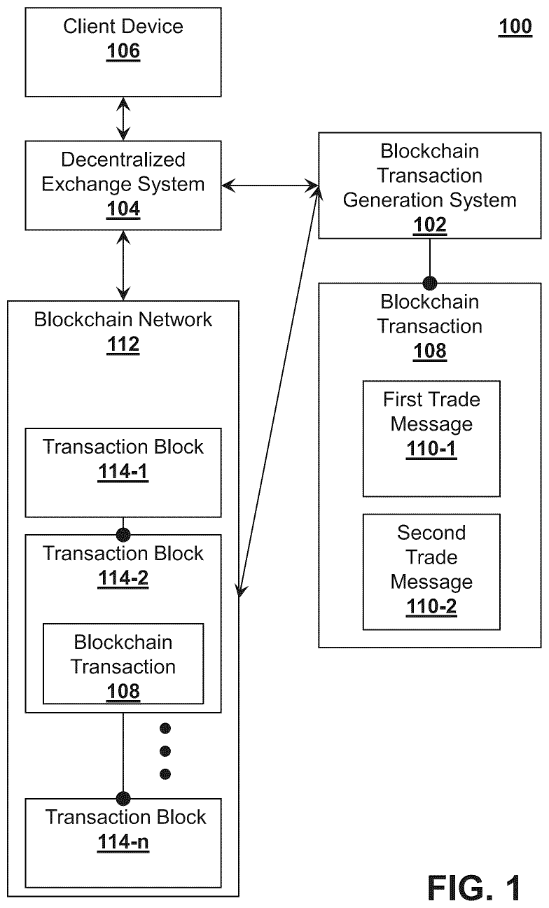

FIG. 1 depicts a system 100 for performing transactions with multiple messages including an arbitrage transaction on a blockchain network within a single blockchain transaction according to some non-limiting embodiments. The system 100 may include blockchain transaction generation system 102, decentralized exchange system 104, client device 106, blockchain transaction 108, trade message 110-1 and trade message 110-2, blockchain network 112, and transaction block 114-1 to transaction block 114-n (e.g., a plurality of transaction blocks, referred to individually as transaction block 114 and collectively as transaction blocks 114 where appropriate).

Blockchain transaction generation system 102 may include a computing device, such as a server (e.g., a single server), a group of servers, and/or other like devices. In some non-limiting embodiments, blockchain transaction generation system 102 may include a processor and/or memory as described herein. In some non-limiting embodiments, blockchain transaction generation system 102 may include one or more servers and/or one or more client devices executing instructions (e.g., software instructions) that cause blockchain transaction generation system 102 (e.g., a processor thereof) to perform one or more steps of methods as described herein. Blockchain transaction generation system 102 may include at least one processor (e.g., a multi-core processor), such as a central processing unit (CPU), an accelerated processing unit (APU), a graphics processing unit (GPU), a microprocessor, and/or the like.

In some non-limiting embodiments, blockchain transaction generation system 102 (e.g., a processor thereof) may be programmed to perform one or more steps of methods described herein. In some non-limiting embodiments, blockchain transaction generation system 102 may include at least one processor executing instructions (e.g., software instructions) that cause the at least one processor to perform one or more steps of methods as described herein. In some non-limiting embodiments, blockchain transaction generation system 102 may be in communication with decentralized exchange system 104 and/or blockchain network 112. In some non-limiting embodiments, blockchain transaction generation system 102 may be capable of receiving information (e.g., data) from and/or communicating (e.g., transmitting) information to decentralized exchange system 104. In some non-limiting embodiments, the at least one processor of blockchain transaction generation system 102 may execute an instance of an application programming interface (API) (e.g., an instance of a blockchain transaction generation API). In some non-limiting embodiments, the API executing on the at least one processor may include a software application and/or software program that receives requests from one or more client devices 106.

Decentralized exchange system 104 may include a computing device, such as a server (e.g., a single server), a group of servers, and/or other like devices. In some non-limiting embodiments, decentralized exchange system 104 may include a processor and/or memory as described herein. In some non-limiting embodiments, decentralized exchange system 104 may include one or more servers and/or one or more client devices executing instructions (e.g., software instructions) that cause decentralized exchange system 104 (e.g., a processor thereof) to receive information from (e.g., blockchain transactions) and transmit information to blockchain transaction generation system 102. decentralized exchange system 104 may include at least one processor (e.g., a multi-core processor), such as a central processing unit (CPU), an accelerated processing unit (APU), a graphics processing unit (GPU), a microprocessor, and/or the like. In some embodiments, decentralized exchange system 104 may include a peer-to-peer marketplace where client devices 106 (e.g., users operating client devices 106) may conduct transactions using a blockchain network to exchange digital currency (e.g., cryptocurrency) without an intermediary.

Client device 106 may include a computing device configured to communicate with decentralized exchange system 104. For example, client device 106 may include a computing device, such as a desktop computer, a portable computer (e.g., a tablet computer, a laptop computer, a smartphone, and/or the like), a mobile device (e.g., a cellular phone, a smartphone, a personal digital assistant, a wearable device, and/or the like), and/or other like devices. In some non-limiting embodiments, client device 106 may be associated with a user (e.g., an individual operating client device 106).

Blockchain transaction 108 may include one or more messages (e.g., trade messages 110). The one or more messages may be configured to be executed by a processor via software instructions (e.g., via a smart contract of blockchain network 112). In some embodiments, client device 106 may request one or more transactions via decentralized exchange system 104 resulting in one or more blockchain transactions 108. The one or more blockchain transactions 108 may be generated by blockchain transaction generation system 102 and may be verified and/or signed on blockchain network 112. In some embodiments, one or more client devices 106 may verify and/or validate the one or more blockchain transactions 108 on blockchain network 112 to generate one or more transaction blocks 114 on blockchain network 112.

First trade message 110-1 may include a trade message representing a user trade. For example, first trade message 110-1 may include a plurality of parameters including a type of message, a first cryptocurrency, a second cryptocurrency, an amount of the first cryptocurrency, an amount of the second cryptocurrency, and one or more pool identifiers. Each of the one or more pool identifiers may represent (e.g., identify) a pool of a cryptocurrency. In some embodiments, first trade message 110-1 may be executed on blockchain network 112 via a smart contract and/or another software function. As first trade message 110-1 may include a trade message representing a user trade, first trade message 110-1 may be initiated by a user (e.g., a user input via client device 106) and may not include a trade message representing an arbitrage trade that is initiated by a smart contract. In some embodiments, first trade message 110-1 and second trade message 110-2 may be executed via a smart contract. The second amount of the second cryptocurrency may be recalculated by the smart contract.

Second trade message 110-2 may include a trade message representing an arbitrage trade (e.g., a type of a user trade). For example, second trade message 110-2 may include a plurality of parameters including a type of message, a first cryptocurrency, a second cryptocurrency, an amount of the first cryptocurrency, an amount of the second cryptocurrency, and one or more pool identifiers. Each of the one or more pool identifiers may represent (e.g., identify) a pool of a cryptocurrency. In some embodiments, second trade message 110-2 may include a first cryptocurrency and a second cryptocurrency that are a same cryptocurrency. In this way, the second trade message 110-2 may include two amounts (e.g., a first amount and a second amount) of a cryptocurrency (e.g., the first cryptocurrency and the second cryptocurrency that are the same cryptocurrency) where the two amounts of the cryptocurrency are different amounts such that second trade message 110-2 represents an arbitrage trade. In some embodiments, second trade message 110-2 may be executed on blockchain network 112 via a smart contract and/or another software function. The two amounts (of the second trade) for given trade routes may be re-calculated via the smart contract. This may ensure a best possible accuracy of the two amounts in the second trade message. This makes the off-chain simulation (e.g., using an off-chain simulator) more accurate (in case the simulation, which runs off-chain, did not have a perfect and/or up-to-date “view” of the blockchain). In some embodiments, second trade message 110-2 may include instructions (e.g., software instructions executable by a processor) to cause execution of a smart contract.

Blockchain network 112 may include a distributed ledger that includes one or more blocks (e.g., records, recorded transactions, transaction blocks 114, and/or the like) including a cryptographic hash, a timestamp, and transaction data associated with one or more blockchain transactions 108. In some embodiments, blockchain network 112 may be distributed among a plurality of nodes (e.g., a plurality of client devices 106) of a computer network (e.g., a peer-to-peer network). In some embodiments, blockchain network 112 may be the same as or similar to a database that may store data (e.g., transaction data associated with one or more blockchain transactions 108) in a digital format.

Transaction block 114-1 to transaction block 114-n may include a plurality of blocks of blockchain network 112 such that each transaction block 114 represents a recorded transaction (e.g., transaction data associated with blockchain transactions 108). In some embodiments, transaction block 114 may be generated after first trade message 110-1 and second trade message 110-2 are executed and after blockchain transaction 108 is verified on blockchain network 112. A blockchain transaction may be added to blockchain network 112 in an order that transactions are executed and verified on blockchain network 112. A block may include a record of data that is ordered and immutable. Each block of a plurality of blocks may have a cryptographic hash of a previous block (e.g., a block recorded prior to a current block), a timestamp, and transaction data associated with a blockchain transaction.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of system 100 may perform one or more functions described as being performed by another set of systems or another set of devices of system 100.

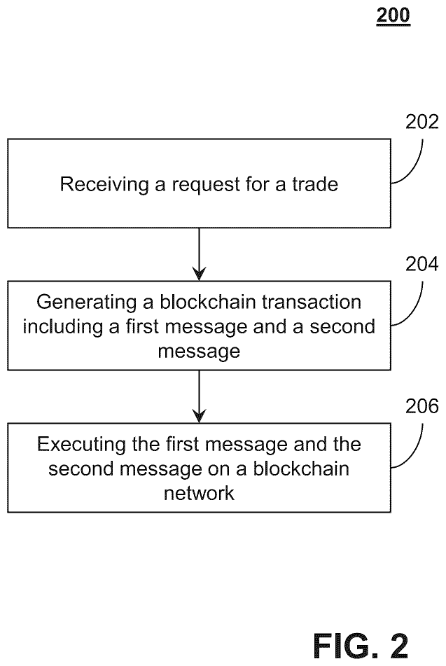

Referring now to FIG. 2, shown is a process 200 for performing transactions with multiple messages including an arbitrage transaction on a blockchain network within a single blockchain transaction according to some non-limiting embodiments. The steps shown in FIG. 2 are for example purposes only. It will be appreciated that additional, fewer, different, and/or a different order of steps may be used in non-limiting embodiments.

As shown in FIG. 2, at step 202, process 200 may include receiving a request for a trade. For example, blockchain transaction generation system 102 (e.g., a processor thereof) may receive a request for a trade from a client device. The request for the trade may include a first amount of a first cryptocurrency.

As shown in FIG. 2, at step 204, process 200 may include generating a blockchain transaction including a first message and a second message. For example, blockchain transaction generation system 102 (e.g., a processor thereof) may generate a blockchain transaction including a first trade message for the first amount of the cryptocurrency and a second trade message for a second amount of a second cryptocurrency. In some embodiments, the first trade message and the second trade message may be executed via a smart contract. The smart contract may include software instructions that cause at least one processor to execute the first trade message and the second trade message.

In some embodiments, at least one processor may execute the first trade associated with the first trade message prior to executing the second trade associated with the second trade message. In some embodiments, at least one processor may execute the first trade associated with the first trade message to swap the first amount of cryptocurrency (e.g., for another cryptocurrency and/or for a fiat currency). The at least one processor may execute the second trade associated with the second trade message to swap the second amount of cryptocurrency for a third amount of cryptocurrency. The second trade represents an arbitrage swap. In some embodiments, the cryptocurrency of the second amount of cryptocurrency may include a first cryptocurrency (e.g., JUNO tokens) and a cryptocurrency of the third amount of cryptocurrency may include a second cryptocurrency (e.g., OSMO tokens). For example, a second amount of JUNO tokens may be swapped for a third amount of OSMO tokens. The third amount of OSMO tokens may be a larger amount than the second amount of OSMO tokens. As another example, 100 ATOM tokens may be swapped for OSMO tokens and the OSMO tokens may be swapped for JUNO tokens using first trade messages. Then, JUNO tokens may be swapped for 101 ATOM tokens using a second trade message (resulting in an overall gain of 1 ATOM token). In some embodiments, the at least one processor may record the first trade and the second trade on a block (e.g., transaction block 114) in the blockchain network.

In another example, a first trade message initiated by a user may cause a first trade (e.g. ATOM tokens for ETH tokens) on a first pool of cryptocurrency. The first trade may cause a price decrease for ATOM tokens and a price increase for of ETH tokens. (This may result because the user wants to sell ATOM and wants to buy ETH). Then, blockchain transaction generation system 102 may detect an opportunity for arbitrage based on the first trade (e.g., by detecting changes in price for ATOM tokens and ETH tokens) and blockchain transaction generation system 102 may execute a second trade to swap another cryptocurrency (e.g., JUNO tokens) to capitalize on the price decrease for ATOM tokens. In this way, the second trade message and thus the second trade may capitalize on the sale of ATOM tokens by the user.

In some embodiments, the first trade message and the second trade message may each include one or more pool identifiers, each pool identifier representing a pool of one or more cryptocurrencies (e.g., a liquidity pool). For example, a pool of one or more cryptocurrencies may include a crowdsourced pool of cryptocurrencies or tokens locked in a smart contract that may be used to facilitate trades between the assets on a decentralized exchange system. Instead of acting as a traditional market including buyers and sellers, decentralized finance platforms may use automated market makers (AMMs). AMMs may allow digital assets (e.g., cryptocurrencies) to be traded in an automatic and permissionless manner through the use of liquidity pools. In this way, executing one or more trades and/or transactions (e.g., blockchain transactions) does not require a buyer to be matched to a seller. Instead, a user may execute a trade to swap a first cryptocurrency with a second cryptocurrency included in the pool of cryptocurrencies. The use of a pool of a cryptocurrency may also allow for a trade and/or a transaction of a first amount of a cryptocurrency for a second amount of the cryptocurrency, thus using the pool of the cryptocurrency to execute an arbitrage trade when the price of the cryptocurrency fluctuates.

As shown in FIG. 2, at step 206, process 200 may include executing the first message and the second message on a blockchain network. For example, blockchain transaction generation system 102 (e.g., a processor thereof) may execute the first trade message and the second trade message on blockchain network 112 to execute a first trade associated with the first trade message and to execute a second trade associated with the second trade message. In some embodiments, blockchain transaction generation system 102 may be deployed on blockchain network 112 such that blockchain transaction generation system 102 may include a smart contract that may execute a second trade message. In this way, blockchain transaction generation system 102 may be an “on-chain” system and/or software application that is deployed on a blockchain network (e.g., blockchain network 112).

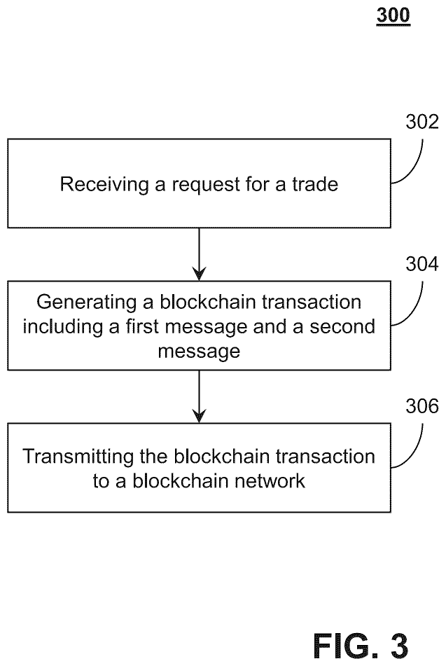

Referring now to FIG. 3, shown is a process 300 for performing transactions with multiple messages including an arbitrage transaction on a blockchain network within a single blockchain transaction according to some non-limiting embodiments. The steps shown in FIG. 3 are for example purposes only. It will be appreciated that additional, fewer, different, and/or a different order of steps may be used in non-limiting embodiments.

As shown in FIG. 3, at step 302, process 300 may include receiving a request for a trade. For example, blockchain transaction generation system 102 (e.g., a processor thereof) may receive a request for a trade from a client device. The request for the trade may include a first amount of a first cryptocurrency.

As shown in FIG. 3, at step 304, process 300 may include generating a blockchain transaction including a first message and a second message. For example, blockchain transaction generation system 102 (e.g., a processor thereof) may generate a blockchain transaction including a first trade message for the first amount of the cryptocurrency and a second trade message for a second amount of a second cryptocurrency.

As shown in FIG. 3, at step 306, process 300 may include transmitting the blockchain transaction to a blockchain network. For example, blockchain transaction generation system 102 (e.g., a processor thereof) may transmit blockchain transaction 108 to blockchain network 112.

In some embodiments, blockchain transaction generation system 102 may receive a request for a trade from a client device. The request for the trade may include a first amount of a first cryptocurrency. Blockchain transaction generation system 102 may simulate a blockchain transaction (e.g., one or more trades) based on the request for the trade to produce a trade result comprising a difference in amounts of cryptocurrency (e.g., a price favorable trade). In some embodiments, blockchain transaction generation system 102 may simulate the blockchain transaction off-chain (e.g., not on a blockchain network). Blockchain transaction generation system 102 may generate a blockchain transaction including a first trade message for the cryptocurrency and a second trade message for the cryptocurrency. The second trade message may include the difference in amounts of cryptocurrency. Blockchain transaction generation system 102 may transmit the blockchain transaction to a blockchain network.

In some embodiments, blockchain transaction generation system 102 may receive a request for a trade from a client device. The request for the trade may include a first amount of a first cryptocurrency. Blockchain transaction generation system 102 may generate a blockchain transaction including a first trade message for the first amount of the cryptocurrency and a second trade message for a second amount of a second cryptocurrency. Blockchain transaction generation system 102 may transmit the blockchain transaction to a blockchain network. In some embodiments, the first trade message and the second trade message may be executed on the blockchain network via a smart contract (e.g., a CosmWasm (Web Assembly) Rust smart contract). Alternatively, the first trade message and the second trade message may be executed on the blockchain network via one or more functions (e.g., a Golang function). In some embodiments, the blockchain transaction may be verified and/or signed on the blockchain network. It should be understood that blockchain transaction generation system 102 may submit a trade using various methods (e.g., on different blockchain systems).

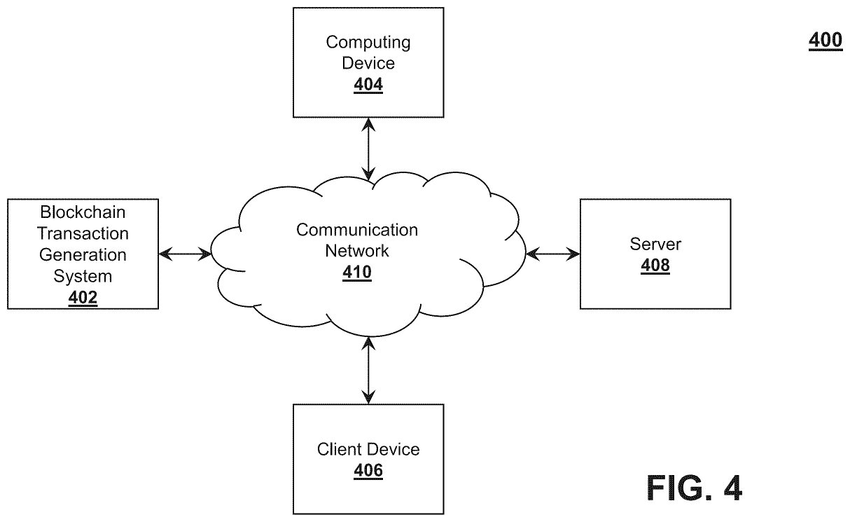

Referring now to FIG. 4, shown is a diagram of a non-limiting embodiment of an exemplary environment 400 in which systems, products, and/or methods, as described herein, may be implemented. As shown in FIG. 4, environment 400 may include blockchain transaction generation system 402, computing device 404, client device 406, server 408, and communication network 410. In some non-limiting embodiments, each of computing device 404, client device 406, server 408, and/or communication network 410 may be implemented by (e.g., part of) blockchain transaction generation system 402. In some non-limiting embodiments, at least one of each of computing device 404, client device 406, server 408, and/or communication network 410 may be implemented by (e.g., part of) another system, another device, another group of systems, or another group of devices, separate from or including blockchain transaction generation system 402, such as computing device 404, client device 406, server 408, and/or the like.

Blockchain transaction generation system 402 may include one or more devices capable of receiving information from and/or communicating information to computing device 404, client devices 406, and/or server 408 via communication network 410. For example, blockchain transaction generation system 402 may include a computing device, such as a server, a group of servers, and/or other like devices. In some non-limiting embodiments, blockchain transaction generation system 402 may be associated with a server as described herein. In some non-limiting embodiments, blockchain transaction generation system 402 may be in communication with a data storage device (e.g., database, memory, and/or the like), which may be local or remote to blockchain transaction generation system 402. In some non-limiting embodiments, blockchain transaction generation system 402 may be capable of receiving information from, storing information in, communicating information to, or searching information stored in the data storage device.

Computing device 404 may include one or more devices capable of receiving information and/or communicating information to blockchain transaction generation system 402, client device 406, and/or server 408 via communication network 410. For example, computing device 404 may include a computing device, such as a server, a group of servers, and/or other like devices. In some non-limiting embodiments, computing device 404 may be associated with a server, a client device, and/or a user device as described herein.

Client device 406 may include one or more devices capable of receiving information from and/or communicating information to blockchain transaction generation system 402, computing device 404, and/or server 408 via communication network 410. Additionally or alternatively, one or more client devices 406 may include a device capable of receiving information from and/or communicating information to other client devices 406 via communication network 410, another network (e.g., an ad hoc network, a local network, a private network, a virtual private network, and/or the like), and/or any other suitable communication technique. For example, client device 406 may include a user device and/or the like.

Server 408 may include a computing device storing a blockchain network. In some embodiments, server 408 may include a plurality of servers including a blockchain network. Server 408 may communicate with computing device 404 and/or client device 406 vis communication network 410 to validate one or more blockchain transactions and/or messages executed on the blockchain network. A blockchain network may be distributed among one or more of computing device 404, client device 406, and/or server 408.

Communication network 410 may include one or more wired and/or wireless networks. For example, communication network 410 may include a cellular network (e.g., a long-term evolution (LTE®) network, a third generation (3G) network, a fourth generation (4G) network, a fifth generation (5G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network (e.g., a private network associated with independent-cache collaboration system 402), an ad hoc network, an intranet, the Internet, a fiber optic-based network, a cloud computing network, and/or the like, and/or a combination of these or other types of networks.

The number and arrangement of systems, devices, and/or networks shown in FIG. 4 are provided as an example. There may be additional systems, devices, and/or networks; fewer systems, devices, and/or networks; different systems, devices, and/or networks; and/or differently arranged systems, devices, and/or networks than those shown in FIG. 4. Furthermore, two or more systems or devices shown in FIG. 4 may be implemented within a single system or device, or a single system or device shown in FIG. 4 may be implemented as multiple, distributed systems or devices. Additionally or alternatively, a set of systems (e.g., one or more systems) or a set of devices (e.g., one or more devices) of environment 400 may perform one or more functions described as being performed by another set of systems or another set of devices of environment 400.

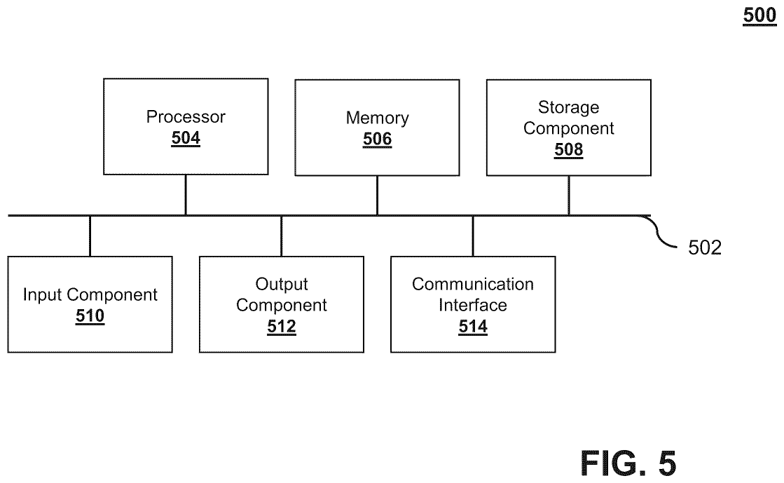

Referring now to FIG. 5, shown is a diagram of example components of a device 500 according to non-limiting embodiments. Device 500 (and/or at least one components of device 500) may correspond to at least one of blockchain transaction generation system 102, decentralized exchange system 104, client device 106, and/or blockchain network 112 in FIG. 1 and/or at least one of blockchain transaction generation system 402, computing device 404, client device 406, and/or server 408 in FIG. 4, as an example. In some non-limiting embodiments, such systems or devices in FIG. 1 or FIG. 4 may include at least one device 500 and/or at least one component of device 500. The number and arrangement of components shown in FIG. 5 are provided as an example. In some non-limiting embodiments, device 500 may include additional components, fewer components, different components, or differently arranged components than those shown in FIG. 5. Additionally or alternatively, a set of components (e.g., one or more components) of device 500 may perform one or more functions described as being performed by another set of components of device 500.

As shown in FIG. 5, device 500 may include bus 502, processor 504, memory 506, storage component 508, input component 510, output component 512, and communication interface 514. Bus 502 may include a component that permits communication among the components of device 500. In some non-limiting embodiments, processor 504 may be implemented in hardware, software (e.g., firmware), or a combination of hardware and software. For example, processor 504 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 506 may include RAM, ROM, and/or another type of dynamic or static storage device (e.g., flash memory, magnetic memory, optical memory, etc.) that stores information and/or instructions for use by processor 504.

With continued reference to FIG. 5, storage component 508 may store information and/or software related to the operation and use of device 500. For example, storage component 508 may include a hard disk (e.g., a magnetic disk, an optical disk, a magneto-optic disk, a solid state disk, etc.) and/or another type of computer-readable medium. Input component 510 may include a component that permits device 500 to receive information, such as via user input (e.g., a touch screen display, a keyboard, a keypad, a mouse, a button, a switch, a microphone, etc.). Additionally or alternatively, input component 510 may include a sensor for sensing information (e.g., a global positioning system (GPS) component, an accelerometer, a gyroscope, an actuator, etc.). Output component 512 may include a component that provides output information from device 500 (e.g., a display, a speaker, one or more light-emitting diodes (LEDs), etc.). Communication interface 514 may include a transceiver-like component (e.g., a transceiver, a separate receiver and transmitter, etc.) that enables device 500 to communicate with other devices, such as via a wired connection, a wireless connection, or a combination of wired and wireless connections. Communication interface 514 may permit device 500 to receive information from another device and/or provide information to another device. For example, communication interface 514 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 500 may perform one or more processes described herein. Device 500 may perform these processes based on processor 504 executing software instructions stored by a computer-readable medium, such as memory 506 and/or storage component 508. A computer-readable medium may include any non-transitory memory device. A memory device includes memory space located inside of a single physical storage device or memory space spread across multiple physical storage devices. Software instructions may be read into memory 506 and/or storage component 508 from another computer-readable medium or from another device via communication interface 514. When executed, software instructions stored in memory 506 and/or storage component 508 may cause processor 504 to perform one or more processes described herein. Additionally or alternatively, hardwired circuitry may be used in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, a request for a trade from a client device, wherein the request for the trade comprises a first amount of a first cryptocurrency;
generating, with at least one processor, a blockchain transaction comprising a first trade message for the first amount of the cryptocurrency and a second trade message for a second amount of a second cryptocurrency; and
executing, with at least one processor, the first trade message and the second trade message on a blockchain network to execute a first trade associated with the first trade message and to execute a second trade associated with the second trade message.

2. The computer-implemented method of claim 1, wherein the first trade message and the second trade message are executed via a smart contract, and wherein the second amount of the second cryptocurrency is recalculated by the smart contract.

3. The computer-implemented method of claim 1, wherein the first trade associated with the first trade message is executed prior to executing the second trade associated with the second trade message.

4. The computer-implemented method of claim 1, wherein executing the first trade message and the second message comprises:
executing the first trade associated with the first trade message to swap the first amount of cryptocurrency; and
executing the second trade associated with the second trade message to swap the second amount of cryptocurrency, wherein the second trade represents an arbitrage swap.

5. The computer-implemented method of claim 4, further comprising:
recording the first trade and the second trade on a block in the blockchain network.

6. The computer-implemented method of claim 1, wherein the first trade message and the second trade message each comprise one or more pool identifiers, each pool identifier representing a pool of one or more cryptocurrencies.

7. The computer-implemented method of claim 1, further comprising:
transmitting, with the at least one processor, the blockchain transaction to a blockchain network.

8. A computer-implemented method, comprising:
receiving, with at least one processor, a request for a trade from a client device, wherein the request for the trade comprises a first amount of a first cryptocurrency;
simulating, with at least one processor, a blockchain transaction based on the request for the trade to produce a trade result comprising a difference in amounts of cryptocurrency;
generating, with at least one processor, a blockchain transaction comprising a first trade message for the cryptocurrency and a second trade message for the cryptocurrency, wherein the second trade message comprises the difference in amounts of cryptocurrency; and
transmitting, with at least one processor, the blockchain transaction to a blockchain network.

9. The computer-implemented method of claim 8, wherein the first trade message and the second trade message are executed on the blockchain network.

10. The computer-implemented method of claim 8, wherein the first trade message and the second trade message are executed via a smart contract, and wherein the second amount of the second cryptocurrency is recalculated by the smart contract.

11. The computer-implemented method of claim 8, wherein the blockchain transaction is verified on the blockchain network.

12. A system, comprising:
at least one processor; and
an application programming interface (API) configured to communicate with a client device and at least one decentralized exchange system, wherein the API is configured to cause the at least one processor to:
receive a request for a trade from the client device, wherein the request for the trade comprises a first amount of a first cryptocurrency;
generate a blockchain transaction comprising a first trade message for the first amount of the cryptocurrency and a second trade message for a second amount of a second cryptocurrency; and
transmit the blockchain transaction to a blockchain network via the decentralized exchange system.

13. The system of claim 12, further comprising:
a blockchain network;
a smart contract deployed on the blockchain network, the smart contract configured to execute one or more messages including a difference in amounts of cryptocurrency to produce a trade result; and
at least one processor, wherein the at least one processor is programmed or configured to:
receive a blockchain transaction from a client device, wherein the blockchain transaction comprises a first trade message and a second trade message, the second trade message including instructions to cause execution of the smart contract; and
execute the first trade message and the second trade message on the blockchain network, wherein the second trade message comprises the difference in amounts of cryptocurrency and is executed via the smart contract.
